(19) United States
(12) Patent Application Publication
(10) Pub. No.: US 2007/0088646 A1
(43) Pub. Date: Apr. 19, 2007

(54) ELECTRONIC TRADING SYSTEM

(75) Inventors: Brian Vincent KELLY, London (GB); Ian David MAWDSLEY, Hertfordshire (GB)

Correspondence Address: TAYLOR RUSSELL & RUSSELL, P.C., 4807 SPICEWOOD SPRINGS ROAD, BUILDING TWO SUITE 250, AUSTIN, TX, 78759, US

(73) Assignee: PATSYSTEMS (UK) LTD., London (GB)

(21) Appl. No.: 11/462,133

(22) Filed: Aug. 3, 2006

(30) Foreign Application Priority Data
Feb. 3, 2004 (GB) 0402435.2

(51) Int. Cl. G06Q 40/00

(52) U.S. Cl. 705/36 R

(57) ABSTRACT

A client terminal for use in an electronic trading system and a method of operating such a system are disclosed. The terminal comprises: a data interface for sending data to and receiving data from a server; a user interface including a display for presenting information to a user and receiving trading commands from a user; and processing means for analysing data received from the server. It may, for example, be implemented in software executed on a personal computer. The processing means is operative to: calculate a bid strength being a weighted summation of current bids; calculate an offer strength being a weighted summation of current offers; and; generate on the display a graphical representation of the bid strength and the offer strength. The representation is intended to provide a quickly intelligible indication of the state of the market. For example, it may include bars (20, 22), the length of which indicates the result of the analysis. It may also include the results presented in FIGS. (24).

This invention relates to an electronic trading system. In particular, it relates to an electronic trading system that can assess a market's sentiment towards a product at any particular time. This invention is particularly concerned with tradable financial instruments (e.g. futures, equities or foreign exchange products) but it could find application to markets that trade in many other types of product.

An increasing number of markets have been converted from a manual system of trading, in which traders operate from a market trading floor, to an electronic system of trading in which traders operate from remotely connected computers. Such electronic markets operate trading host computers, which actually perform the trading function. The traders interact with the hosts by means of client terminals, connected to the host by a local area and/or wide area network link. The client terminal executes software that generates a display that allows a trader to be appraised of the status of the market and to perform trading activities.

Clearly, it is of particular importance that information relating to the market is provided to the trader in a clear and timely manner. This is essential as it allows the trader to buy and sell commodities at a desired price, dependent upon the instantaneous state of a changing market. In a market that is prone to rapid changes in price, this presents a considerable technical challenge.

The concept of market sentiment can be thought of as defining the collective mood of traders in a market towards a tradable item. Experienced traders can judge market sentiment and adjust their trading activities accordingly. However, assessment of market sentiment has until now been a subjective matter, and not something that could be implemented within an automated trading system. Moreover, it has involved the assessment of a large amount of data presented in, for example, tabular form upon the display of a client terminal. Even highly experienced traders find it difficult to assess such a quantity of data sufficiently quickly to ensure that the assessment can be reached in a timely manner before the state of the market has changed.

Market sentiment can be an important indicator as to the correct trading behaviour with respect to a market, and a lack of knowledge of market sentiment puts a trader (human or automated) at a disadvantage. Therefore, a principal aim of this invention is to provide a method for quantifying market sentiment that can be automated to provide an indication of market sentiment to a human or automated trader. It is a further aim of the invention to provide a trading client that is capable of generating a display that represents market sentiment in a manner that can be assimilated quickly and accurately by a market trader using the client computer.

From first aspect, this invention provides a client terminal for use in an electronic trading system comprising: a data interface for sending data to and receiving data from a server; a user interface including a display for presenting information to a user and receiving trading commands from a user; and processing means for analysing data received from the server; characterised in that: the processing means is operative to

a. calculate a bid strength being a weighted summation of current bids;

b. calculate an offer strength being a weighted summation of current offers; and;

c. generate on the display a graphical representation of the bid strength and the offer strength.

Thus, the task of assessing the market by analysing some or all of the bids and offers is removed from the user and given to the client terminal. This allows the user to concentrate upon trading activity, rather than having to perform analysis of large amounts of data.

The graphical representation may include a numerical representation of the bid strength and the offer strength. Alternatively or additionally, the graphical representation may include one or more of a pie chart and a bar chart, or another easily recognised and understood graphical device.

Most preferably, the graphical representation is updated substantially in real time to reflect an instantaneous state of the market. This allows a trader to make decisions in a more timely manner than would have previously been possible.

The graphical representation may be a component part of a more complex graphical user interface.

From a second aspect, this invention provides a method of assessing the sentiment of a trading market comprising:

a. calculating a bid strength being a weighted summation of all current bids;

b. calculating an offer strength being a weighted summation of all current offers; and

c. permitting comparison of the bid strength and the offer strength.

This can give a trader an indication to a trader of the relative disposition of traders in the market towards buying and selling at any instant.

Step c. may involve simply displaying the results of the calculations of steps a. and b. on a display whereby they can be compared by a user. In simple embodiments, the results may be displayed as numerical values. Preferred embodiments may represent the results graphically in a chart such as a bar chart or a pie chart.

Step c. may additionally or alternatively involve making the values available to other software components, where they can be interpreted to, optionally, influence the operation of the further components.

The particular values that are calculated in steps a. and b. are dependent upon the applied weighting functions. These may be determined experimentally, for example by determining which functions give values that most closely accord with the subjective impression of a market that is obtained by an experienced trader. The appropriate weighting functions might typically vary from one market to another. For example, the functions may be linear or non-linear, or may have multiple components. For example, a non-linear component may be a discrete function, such as a function that selects numbers from a Fibonacci sequence may produce favourable results. This usefulness of this particular function was discovered by analysis of the graphs of various functions and such analysis may reveal further useful functions for use in embodiments of the invention.

Embodiments of the invention may include a step of calculating a centre price being the mean of the lowest current offer and the highest current bid, the weighting functions calculating a comparison between the centre price and a bid or offer.

Upon assessment of the values calculated by this method, a decision may be made whether or not to trade in a market and, if the decision is made to trade whether to buy or to sell in the market. This may be performed by a human trader or by an automated trading system.

From a third aspect, this invention provides a computer software component that implements a method according to the second aspect. Such a component may be a stand-alone application or a modular component of a larger application.

From a fourth aspect, this invention provides client device for use in an electronic trading system comprising a computer software component according to the third aspect of the invention, and a computer for executing the software component.

An embodiment of the invention will now be described in detail, by way of example, and with reference to the accompanying drawings, in which:

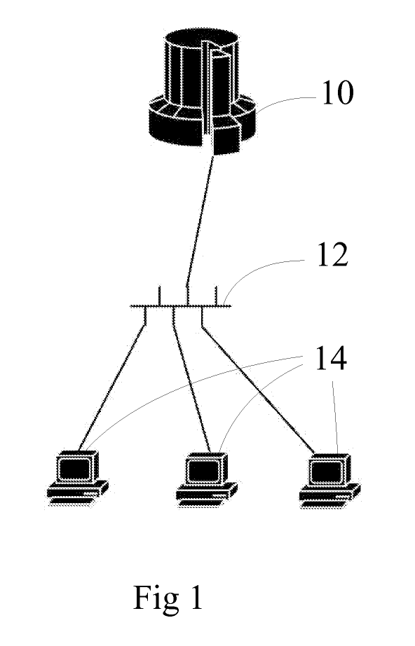

FIG. 1 is a generalised overview of an electronic market comprising a host computer and several trading client terminals connected to it;

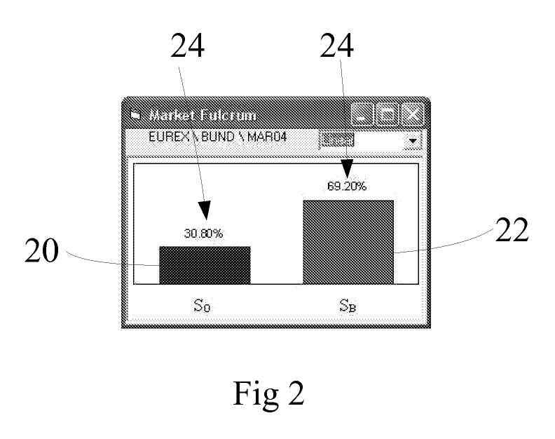

FIG. 2 shows a portion of the display of a client terminal illustrating an embodiment of the invention; and

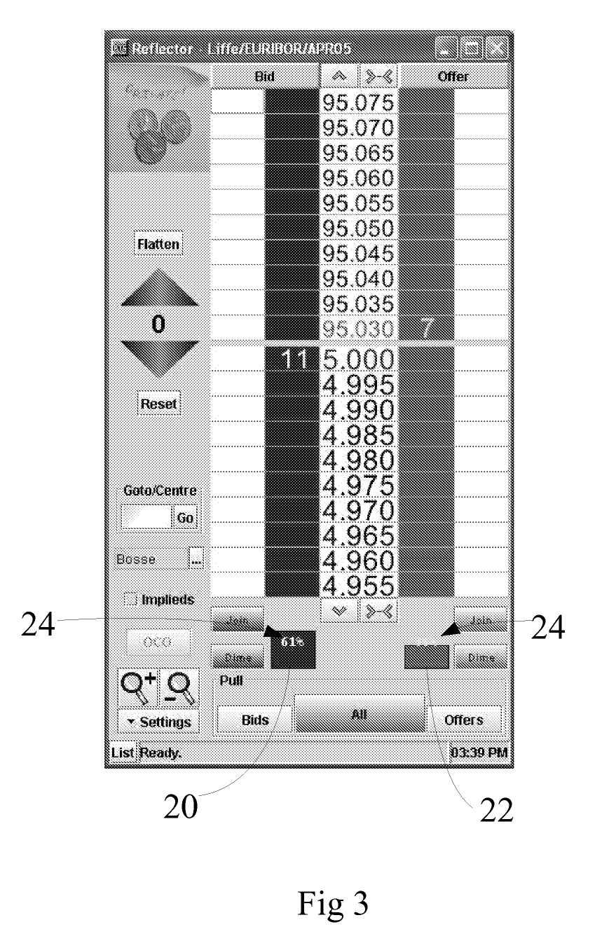

FIG. 3 shows a trading screen incorporating a display being an alternative embodiment of the invention.

With reference first to FIG. 1, a typical electronic market can be represented as several computers connected in a network in a client/server arrangement.

The organisation running the market provides a server computer 10. This is connected over a network 12 to multiple client computers 14, each constituting a client terminal.

The network can include many diverse components, some local-area and some wide-well area, as required by the geographical distribution of the clients, and may, for example, include local-area Ethernet, long-distance leased lines and the Internet

In a typical case, the server is a high-powered computer or cluster of computers capable of handling substantially simultaneous requests from many clients. Each client terminal is typically a considerably smaller computer, such as a single-user workstation. For the purposes of this illustrative embodiment, each client terminal is a personal computer having a Java virtual machine running under the Microsoft Windows XP operating system.

When a client 14 connects to the server 10, it is delivered over the network 12 a stream of data that represents the instantaneous state of the market. This data includes a description of all outstanding bids and asks, and of any trading activity within the market. The client 14 includes a user interface that has a graphical display. The content of the graphical display is updated, in as near as possible real-time, to reflect the instantaneous state of the market in a graphical form. The client 14 can also send a request over the network 12 to the server 10 to initiate a trading action. Typically, each client may be able to connect to several hosts to enable it to trade in several markets.

The above description is a simplification of an actual implementation of an electronic trading system. However, the components described are entirely familiar to those skilled in the technical field, as will the details of how they might be implemented in practice, so they will not be described here further.

Each client 14 executes a software program that allows a user to interact with the server 10 by creating a display that represents data received from the server 10 and sending requests to the server 10 in response to a user's input. In this embodiment, the software program is a Java program (or a component of a Java program) that executes within the virtual machine. The data received from the server includes at least a list of prices and the number of bids or asks at each of the prices. Implementation of the embodiment as a software component or a computer software product can be carried out in many alternative ways, as best suited to a particular application, using methodologies and techniques were unknown to those skilled in the technical field.

FIG. 2 shows a display component on a graphical user interface of an output generated by a method embodying the invention.

This embodiment provides a concept to directly compare the supply and demand for a financial instrument (e.g. a future, an equity or a foreign exchange product) and hence determine the ‘sentiment’ of the market to the financial instrument at an exact moment in time. The supply (offers) and demand (bids) within an order book are each examined separately, accumulated, and then directly compared using an algorithm that will be described. The result of the comparison is then displayed on a graphical ser interface of a client terminal in a manner that can be comprehended quickly by a trader.

For example, consider the supply side of a March Bund future with a simplified order book as follows:
39 contracts are available at 115.02 (best sale price)→1st element
50 contracts are available at 115.03 (next best sale price, etc)→2nd element
10 contracts are available at 115.04 3→rd element
25 contracts are available at 115.05 4→th element
90 contracts are available at 115.06 (worst sale price)→5th element

The amount of the instrument available at the best sale price constitutes the first element of the ‘supply sentiment’. The amount of the instrument available at the next best price constitutes the second element of the ‘supply sentiment’, and so on until the worst sale price available. Each element is then weighted, using one of a number of available options. Using a suitable weighting (several alternative formulae are suggested below), a centre point is determined between the best sale price and the best buy price.

If there is on the demand side a simplified order book as follows:
10 contracts are wanted for 115.01 (best buy price)
5 contracts are wanted for 115.00 (next best buy price, etc) then the centre point would be (115.02+115.01)/2, which equals 115.015. Each element on the supply side is weighted as a function of its relative distance from this centre point. All weighted elements are then summed to determine the total ‘supply sentiment’. This weighting process is repeated for the demand side of the order book to determine a ‘demand sentiment’.

Both supply sentiment and demand sentiment are then compared relative to one another and presented as a percentage value (e.g. 69.2% v. 30.8%). The resulting percentages are then displayed to a user in a graphical form using any of a large number of alternative known techniques. (A number of charts types are applicable for such a display, such as a bar chart or a pie chart). In this example, a bar chart is used. FIGS. 2 and 3 illustrate how such a chart may be displayed, respectively, in a dialog box on a computer display, and as part of a larger trading screen. In both cases, the demand sentiment is displayed as a vertical blue bar 20, and the supply sentiment is displayed as a vertical red bar 22, the height of each bar 20,22 being proportional to the calculated value. The calculated value may be displayed in figures adjacent to, above are or within a corresponding bar, as shown at 24.

The display is updated immediately (within the limitations of the computer hardware) after the values have been calculated. In the latter case, the results of the calculations may be used to influence the operation of other parts of the application, for example, influencing whether or not trading is recommended in that market.

The principal benefits afforded by this embodiment are that:
it provides understanding of where the market is in one glance—that is, it provides a representation of the state of the entire market that is immediately and intuitively comprehensible;
it provides that understanding more rapidly than would be possible if the trader were to perform a mental analysis of the state of the market;
it highlights imbalances between supply and demand; and
it can provide a trading advantage by simplifying a series of complex information into a simple model, hence facilitating quicker decision making

The details of the calculation performed will now be described.

Let P_{c}=Centre Price=mean of lowest offer and highest bid (see equation 1, below), and n=position of price relative to lowest offer/highest bid price of current offer/bid price, respectively.

Also, let:

P_{Bl}=Bid price at n=1 (highest bid) P_{Ol}=Offer price at n=1 (lowest offer)

P_{Bn}=Bid price at position n P_{On}=Offer price at position n

V_{Bn}=Bid volume at position n V_{On}=Offer volume at position n

W_{Bn}=Bid weight at position n (see W_{On}=Offer weight at position n (see

weighting alternatives below) weighting alternatives below)

W_{BT}=Total bid weight (see equation 2) W_{OT}=Total offer weight (see equation 3)

S_{B}=Bid strength (see equation 4) S_{O}=Offer strength (see equation 5)

Then, for a total number of bids m and of offers 1:

$$\begin{matrix}Pc = \frac{( {P}_{O 1} + {P}_{B 1} )}{2} & ( 1 ) \\ {W}_{BT} = {\sum }_{n = 1}^{m} {V}_{Bn} \cdot {W}_{Bn} & ( 2 ) \\ {W}_{OT} = {\sum }_{n = 1}^{m} {V}_{On} \cdot {W}_{On} & ( 3 ) \\ {S}_{B} = \frac{{W}_{BT}}{{W}_{OT} + {W}_{BT}} & ( 4 ) \\ {S}_{O} = \frac{{W}_{OT}}{{W}_{OT} + {W}_{BT}} & ( 5 )\end{matrix}$$

From these formulae, the displayed values S_{O} and S_{B} are calculated.

The embodiment proposes three methods to weight the bid/offer volume, labelled A, B and C below. In the example shown in FIG. 1, the weighting method to be applied to the data prior to its being displayed can be selected by a user in from entries in a drop-down list box.

A: Linear—weights the bid/offer volume based on the relative distance of the price in question from the centre price:

$$\begin{matrix}{W}_{On} = \frac{1}{{P}_{On} - {P}_{C}} & ( 6 ) \\ {W}_{Bn} = \frac{1}{{P}_{C} - {P}_{Bn}} & ( 7 )\end{matrix}$$

B: Fibonacci—weights the bid/offer volume based the Fibonacci number series:
W_{On}=W_{Bn}=Fₙ (8)
(e.g. F₁=21, F₂=13, F₉=0) That is, for a set of m values, Fₙ is the (1+m−n)th value from the Fibonnacci sequence {0, 1, 1, 2, 3, 5 . . . }

C: Combined—a combination of A and B above:

$$\begin{matrix}{W}_{On} = \frac{1}{{P}_{On} - {P}_{C}} \cdot {F}_{n} & ( 9 ) \\ {W}_{Bn} = \frac{1}{{P}_{C} - {P}_{Bn}} \cdot {F}_{n} & ( 10 )\end{matrix}$$

Java is a registered trade mark of Sun Microsystems.

Microsoft and Windows are registered trade marks of Microsoft Corporation

1. A client terminal for use in an electronic trading system comprising: a data interface for sending data to and receiving data from a server; a user interface including a display for presenting information to a user and receiving trading commands from a user; and processing means for analysing data received from the server; characterised in that: the processing means is operative to
a. calculate a bid strength being a weighted summation of current bids;
b. calculate an offer strength being a weighted summation of current offers; and;
c. generate on the display a graphical representation of the bid strength and the offer strength.

2. A client terminal according to claim 1, in which the graphical representation includes a numerical representation of the bid strength and the offer strength.

3. A client terminal according to claim 1, in which the graphical representation includes one or more of a pie chart and a bar chart.

4. A client terminal according to claim 1, in which the graphical representation is updated substantially in real time to reflect an instantaneous state of the market.

5. A client terminal according to claim 1, in which the graphical representation is a component part of a more complex graphical user interface.

6. A method of assessing the sentiment of a trading market comprising:
a. calculating a bid strength being a weighted summation of all current bids;
b. calculating an offer strength being a weighted summation of all current offers; and
c. permitting comparison of the bid strength and the offer strength.

7. A method according to claim 6 in which step c. involves displaying the results of the calculations of steps a. and b. on a display.

8. A method according to claim 7 in which the results are displayed as numerical values.

9. A method according to claim 6 in which the results are displayed graphically in a chart such as a bar chart or a pie chart.

10. A method according to claim 6 in which step d. additionally or alternatively includes making the values available to other software components.

11. A method according to claim 10 in which the values influence the operation of the further software components.

12. A method according to claim 6 in which the weighting functions are determined experimentally.

13. A method according to claim 12 in which the weighting functions are determined as being those functions that give values that most closely accord with the subjective impression of a market that is obtained by an experienced trader.

14. A method according to claim 6 in which it the weighting function applied is dependent upon the market in which trading is taking place.

15. A method according to claim 6 further including a step of calculating a centre price being the mean of the lowest current offer and the highest current bid, the weighting functions calculating a comparison between the centre price and a bid or offer.

16. A method according to claim 6 in which the weighting functions are: linear, non-linear, or linear and non-linear components.

17. A method according to claim 16 in which the weighting functions include a discrete non-linear component.

18. A method according to claim 17 in which the non-linear component is a function that selects numbers from a Fibonacci sequence

19. A method of trading in a market comprising:
a. assessing the sentiment of the market by way of a method according to any preceding claim; and
b. upon assessment of the values calculated by this method, a decision is made whether or not to trade in a market and, if the decision is made to trade whether to buy or to sell in the market.

20. A method of trading in a market according to claim 19 performed by an automated trading system.

21. A method of trading in a market according to claim 19 in which the market is for trading financial instruments.

22. A computer software component that implements a method of assessing the sentiment of a trading market comprising:
a. calculating a bid strength being a weighted summation of all current bids;
b. calculating an offer strength being a weighted summation of all current offers; and
c. permitting comparison of the bid strength and the offer strength.

23. A computer software component according to claim 22 that is a stand-alone application.

24. A computer software component according to claim 22 that is a modular component of a larger application.

25. A client device for use in an electronic trading system comprising a computer software component according to claim 22, and a computer for executing the software component.
